(19) United States
(12) Patent Application Publication
(10) Pub. No.: US 2008/0147581 A1
(43) Pub. Date: Jun. 19, 2008

(54) Processes for Generating Precise and Accurate Output from Untrusted Human Input

(76) Inventors: Daniel J. Larimer, Christiansburg, VA (US); Patrick C. Roye, Blacksburg, VA (US); Aaron R. Pierce, Blacksburg, VA (US)

Correspondence Address: LATIMER, MAYBERRY & MATTHEWS IP LAW, LLP, 13873 PARK CENTER ROAD, SUITE 106, HERNDON, VA, 20171, US

(21) Appl. No.: 11/612,180

(22) Filed: Dec. 18, 2006

(51) Int. Cl. G06N 5/02

(52) U.S. Cl. 706/45

(57) ABSTRACT

The present invention relates to the field of computers and computer programs. More specifically, the present invention relates to programs, systems, methods, and media for providing accurate, reliable, relevant, or otherwise useful output generated from user input with unknown accuracy, reliability, relevance, or usefulness, and software to perform the above task. The present invention includes the generation an output through the aggregation of weighted input from multiple users and the process for generating said weight. The weight is calculated from the historical differences between a users prior input to questions and the corresponding system output.

### BACKGROUND OF THE INVENTION

1. Field of the Invention

The present invention relates to the field of computers and computer programs. More specifically, the present invention relates to programs, systems, methods, and media for providing accurate, reliable, relevant, or otherwise useful output generated from user input with unknown accuracy, reliability, relevance, or usefulness, and software to perform the above task.

2. Description of Related Art

There are many problems that computer algorithms cannot easily solve. Such problems include understanding abstract ideas, recognizing complex patterns, and making subjective evaluations. In order to address these problems, people have developed processes that combine computer algorithms and human interaction. For small problems, a few users may be able to provide all of the required input; however, many problems are too large for a small group of users to handle. Such problems require a community of users to collaborate with an algorithm in order to produce a solution. Since these processes use input from a community of users to derive their solutions, the accuracy of the solutions depends upon the average accuracy of the input from the community of users. For small groups of users, it is possible to pre-select qualified and trusted group members; however, large problems may require thousands of users. For such problems, there must be a means to evaluate the quality of input from individual users.

There have been many solutions to evaluate user input. Some widely known websites that take input from thousands of users include: Slashdot, Digg, eBay, Wikipedia, Google Image Labeler, and Amazon. Most of these websites ask users to rate the input of other users as a means to identify which input to trust and which input not to trust.

Slashdot has moderators to rate user comments and meta-moderators to rate the input from the moderators. One disadvantage with the Slashdot approach, however, is that the need for moderators and meta-moderators grows with the number of posted comments. Slashdot has to limit moderation power to specific users and for limited periods of time in order to prevent abuse.

Digg uses a popularity contest to sort posted comments and articles. Any user may post a comment or may add a link to a news article. Other users may then give a thumb's up or thumb's down on an individual user's input. The more positive input a comment or article receives, the higher it moves on the site. One drawback of this approach is that popularity alone does not make an input accurate. An additional disadvantage with the Digg approach is that not all users provide the same quality of vote.

eBay asks users to provide feedback about other users in order to generate a user rating. The user rating is then provided to other buyers and sellers for their use. The user rating is not analyzed or processed by eBay in an attempt to identify and sort out inaccurate feedback. Thus, eBay's process provides limited means to prevent one user from providing inaccurate feedback about another user. When inaccurate feedback is provided, the best a user of the eBay system can hope for is for the inaccurate feedback to be mutually withdrawn.

Wikipedia has people manually policing changes made to the site. Changes within the Wikipedia system may be made by anyone, and vandalism is common. To handle disputes that arise among users, Wikipedia implements a conflict resolution process. This conflict resolution process, however, requires people to negotiate with other people and can be slow and costly.

Google has implemented a process called Google Image Labeler. Two users are randomly paired and shown a random selection of images. Each user is asked to list words that describe the image. If the users agree, then the process accepts the words as accurate. A limitation of this process is that it does not easily apply to other applications and that only two people are consulted per image instead of thousands.

Amazon and other product review sites simply average all reviews to generate a single rating ranging from 0 to 5 stars. In these types of rating systems, there is no means to identify whether a review is accurate. Therefore, the generated results can be unreliable as they include input from biased and unbiased users equally. For instance, in such product review systems, a user who is always unsatisfied could potentially contribute an irrationally poor review of a product that is highly reviewed by other users.

In existing ranking systems, such as those of Slashdot, Digg, eBay, Wikipedia, Google Image Labeler, and Amazon described above, all user input is equally weighted. Results from these systems, thus, can be unreliable, as the results generated can be based on both biased and unbiased input. The input from biased and unbiased users is equally weighted in these systems because there have been limited means to identify the relative quality of a user's input. Although moderators and meta-moderators have been used in an attempt to identify the quality of user input, systems using such a configuration need additional resources in order to monitor and rate the meta-moderators, i.e., additional user input is needed to process the initial input. Thus, there is a need in the art for improved ranking systems.

### SUMMARY OF THE INVENTION

The present invention seeks to improve upon existing ranking systems by providing automated processes for ranking user input to achieve more reliable results and eliminating the need for users to directly rate input from other users. The present invention relates to programs, software, systems, methods, and media for generating output from user input by using historical user accuracy data to analyze and weigh user input. The present invention further relates to methods for generating accurate, reliable, relevant, or otherwise useful output from user input with unknown accuracy, reliability, relevance, or usefulness. The methods, also referred to herein as processes, of the present invention include processes for generating precise and accurate output from untrusted human input.

The methods of the present invention generally compare an output (for example, generated by the weighted aggregation of all user inputs) to the original input from each user to generate a measurement indicating the usefulness of the user's input, such as accuracy, reliability, and/or relevance. This measurement can then be used by the process to weight future input to the process by the same user. Over time, the process can use the historic user data to automatically identify users who provide accurate information and those that do not. A computer process cannot always determine real accuracy; therefore, the inventive process measures accuracy as the degree to which a user agrees with a majority (the aggregation of weighted input of other users). By weighting user input according to the historic user data, which represents past performance of a user, the output of the process is expected to become increasingly accurate, relevant, reliable, or otherwise useful. As the output of the process becomes more accurate the measurement of a user's accuracy becomes more accurate, which will result in yet more accuracy in future output to the system. The embodiments of this process operates on the theory that an answer derived from a group of people is likely more accurate than the answer from any random member of the group, combined with the theory that an individual user is likely to contribute an input of similar quality to past input.

The processes of the present invention can start by posing a question, whether directly or implied, to one or more users. A user then provides an answer to the question posed by the process. The user's answer is combined with the historical differences between a user's previous answers and the system's previous answers using a weighting algorithm. The combined answer and weight are sent to the central algorithm, which combines the user's weighted answer with the weighted answers of all other users. The central algorithm generates the process' answer based on this information. The process' answer is then passed to an algorithm to compare the process' answer with the answer of the user. The result of the comparison algorithm is an adjustment that can be applied to the user's historical data.

In general, the present invention comprises generating output from user input comprising presenting at least one user with a question, gathering input from said at least one user, reading historic user data for said at least one user, generating an output using said input and said historic user data, comparing said output to said input to generate an adjustment factor, and adjusting said historic user data with said adjustment factor. The present invention also comprises generating output from user input comprising presenting at least one user with a question, gathering input from said at least one user, reading historic user data for said at least one user, and generating an output using said input and said historic user data.

The present invention includes software, programs, systems, methods, and media for generating output from user input comprising instructions for presenting at least one user with a question, gathering input from said at least one user, reading historic user data for said at least one user, generating an output using said input and said historic user data, comparing said output to said input to generate an adjustment factor, and adjusting said historic user data with said adjustment factor. Even further, the present invention also includes software, programs, systems, methods, and media for generating output from user input comprising presenting at least one user with a question, gathering input from said at least one user, reading historic user data for said at least one user, and generating an output using said input and said historic user data.

Embodiments of the present invention include performing multiple iterations of the presenting, gathering, reading, generating, comparing, and adjusting. Embodiments also include performing multiple iterations of the presenting, gathering, reading, and generating. In preferred embodiments, the presenting, gathering, reading, generating, comparing, and adjusting are performed consecutively at least one time, for example, at least two times. In preferred embodiments, the presenting, gathering, reading, and generating are performed consecutively at least one time, for example, at least two times.

Preferred embodiments include performing all or some of the presenting, gathering, reading, generating, comparing, and adjusting. For example, at least one iteration of the presenting, gathering, reading, generating, comparing, and adjusting can be performed and then at least one of the presenting, gathering, reading, generating, comparing, and adjusting can further be performed. Further, for example, at least one iteration of the presenting, gathering, reading, and generating can be performed and then at least one of the presenting, gathering, reading, generating, comparing, and adjusting can further be performed.

Preferred embodiments of the present invention also include generating output from user input comprising presenting at least one user with a question, gathering input from said at least one user, reading historic user data for said at least one user, generating an output using said input and said historic user data, comparing said output to said input to generate an adjustment factor, and adjusting said historic user data with said adjustment factor, then presenting at least one user with a question, gathering input from said at least one user, reading historic user data for said at least one user, and generating an output using said input and said historic user data. In performing such multiple iterations of the present invention, the historic user data can be adjusted at least one time.

Various embodiments of the present invention are envisioned. Such embodiments include storing the historic user data in at least one database. Additionally, the question presented to a user and/or the input gathered from a user can be presented and/or gathered by way of a web page and/or desktop application. If using a desktop application, the desktop application can be networked by way of a client/server architecture or a peer-to peer connection.

The present invention can comprise hardware and/or software, which in general can comprise at least one processor for processing data and/or computer code. Generally, such hardware can comprise a computer or computing device. The hardware can comprise any suitable components known in the art as applicable for computer hardware. Additionally, the invention can comprise a storage medium for storing computer programs, files, data, etc. The storage medium may be any of the known media for long-term or short-term storage of information. In some embodiments, the storage medium is a database or a portable storage medium, which can be inserted and removed from a computer.

In embodiments, an additional advantage that can be achieved by the inventive processes is that there is no need to limit how often a user may moderate because there is a continual incentive for providing good input and disincentive for providing bad input.

This process operates on the theory that more accurate, reliable, relevant, and appropriate input will be provided than inaccurate, unreliable, irrelevant, or inappropriate input; however, it may also work in situations where only a minority of the input is reliable and the majority of the input is strongly biased in two or more opposite directions. When the majority of the input is biased in two or more opposite directions then the average input will be in the middle of the input space. Non-biased users will tend to be closer to the average more often than biased users. As a result, the biased user's input will be weighted less than the non-biased user's input. As users continue to use the process, the process will dynamically adjust the weight of new input from each user based upon the past performance of each user relative to the other users in the system. This process, which weights all input according to past performance, will generate more accurate, reliable, relevant, and appropriate output than a process that does not consider past performance. This is another example of how the inventive process is different from the current art. Using input from users to directly evaluate input from other users results in biased input evaluating biased input, which will lead to biased output.

The processes of the invention may be implemented in numerous ways. For example, the processes may be implemented by providing a web-based interface that presents users with questions (implied or directly) and accepts input from the users. Further, for example, a database may be provided to store questions, answers, and user data. Software algorithms could then perform operations on the provided database to generate the process output, which may then be used by other users and also used to update the user ratings in the provided database.

Even further, for example, alternative implementations may use client/server or peer-to-peer networked computer programs and may manage the data using internal data structures instead of a database. The precise nature of the user interfaces and algorithms depends upon the particular embodiment. In many embodiments the algorithms and data structures required are readily developed using common software development techniques.

### BRIEF DESCRIPTION OF THE DRAWINGS

Elements of the figures are numbered such that the first digit corresponds to the figure number and the second two digits correspond to a portion of the figure. The thickness of the arrows represent relative accuracy and precision such that direct user input has the lowest accuracy, weighted input has an average accuracy, and the average of weighted input has the highest accuracy. The different lines are provided to aid the understanding of the theory of operation and should not be interpreted as a part of the process.

The following is a list of Reference Numerals provided in the figures:
101 User Answer
102 Weighting Algorithm
103 Historic Accuracy Rating
104 Central Algorithm
105 Comparison Algorithm
106 Process' Answer (Final Output)
107 A User
108 Combined user Answer and Weight
109 Combined Answers and Weights
110 Other Users' Answers
201 Moderator Input
202 Weighting Algorithm
203 Historic Accuracy Rating (Karma)
204 Weighted Average Algorithm
205 Comparison Algorithm (3-abs(206-101))
206 Process' Weighted Average
207 A User
208 Combined User Answer and Weight
209 Combined Answers and Weights
210 Other Users' Input
211 Comment Poster
212 Poster's Comment
213 Algorithm to Determine Initial Score
214 Initial Output
215 Poster's Karma
216 Algorithm to Adjust Poster's Karma
217 Other Moderators
218 System's Final Output (Scored Comment)
300 Comment Poster
301 Posted Comment
302 Weighting Algorithm
303 Karma
304 Posted Comment and Initial Rating
305 Output (Comment with Rating)
306 Karma Adjustment Algorithm
307 Moderator Input
308 Moderator User
309 Meta Moderator's Input
310 Moderation Point Algorithm
311 Moderator's Karma
312 Meta-Moderator User

FIG. 1 is a flowchart exemplifying a general process of the invention. In particular, the flowchart describes a process for evaluating a question answered by one or more users.

FIG. 2 provides a flowchart describing a process of the invention modified for use in a comment moderation embodiment.

FIG. 3 is a comparative example, which provides a flowchart describing the existing Slashdot moderation system.

### DETAILED DESCRIPTION OF VARIOUS EMBODIMENTS OF THE INVENTION

Reference will now be made in detail to various exemplary embodiments of the invention. It is to be understood that the following detailed description is presented for the purpose of describing certain embodiments in detail. Thus, the following detailed description is not to be considered as limiting the invention to the embodiments described. Rather, the true scope of the invention is defined by the claims.

The processes of the present invention could be used in numerous applications. Some applications include but are not limited to, for example, Forum Moderation, Massively Multi-User Grammar Checking, Massively Multi-User Language Translation, Massively Multi-User Truth Detection, Massively Multi-User Patent Evaluation, Massively Multi-User Spam Filtering, Massively Multi-User Web Searching, Massively Multi-User Intelligence Gathering, Automated Moderation of a Collaboratively Edited Encyclopedia, and Training of Artificial Intelligence Systems. Indeed, the processes of the present invention can be applied in any situation where data is gathered through user input and where it is desired to obtain increased reliability and accuracy from the output of such data by evaluating, weighting, or analyzing the user input in conjunction with historic user data.

### Evaluation of a Question Answered by One or More Users

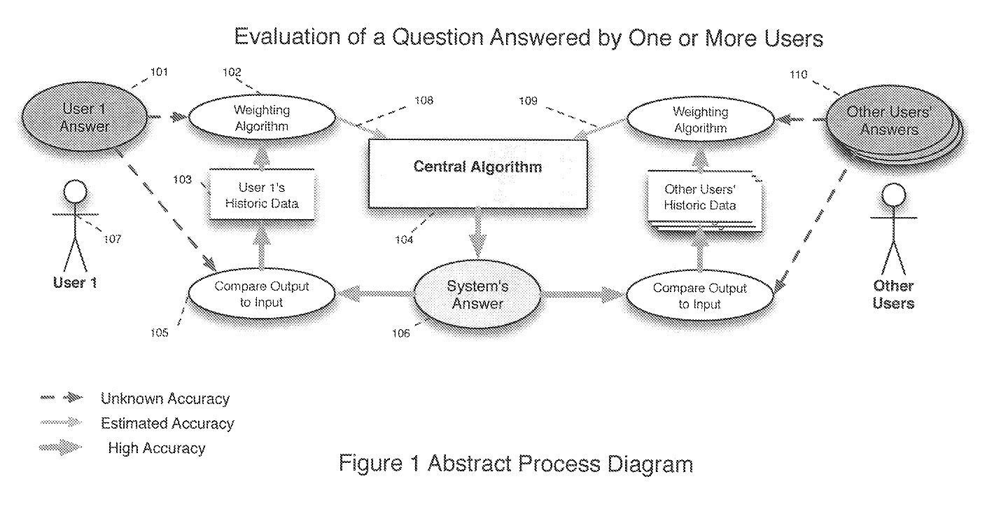

A general embodiment of the invention relates to evaluation of a question answered by one or more users. Such an exemplary embodiment is shown in FIG. 1. The general process description presented in FIG. 1 could serve as a model for numerous configurations.

The process shown in FIG. 1 can start by posing a question (either directly or implied) to one or more users. A user 107 provides their answer 101 to the process. Answer 101 is combined with the user's current rating 103 (if the rating is available) using a weighting algorithm 102. The combined answer and rating 108 get sent to the central algorithm 104 that combines the user's weighted answer 108 with the weighted answers 109 of all other users' answers 110. The central algorithm 104 generates the process' answer 106. Answer 106 is then passed to algorithm 105 to compare answer 106 with answer 101. The result of algorithm 105 is an adjustment to user's rating 103. The output of this process is answer 106.

This process operates on the theory that more accurate, reliable, relevant, and appropriate input will be provided than inaccurate, unreliable, irrelevant, or inappropriate input; however, it may also work in situations where only a minority of the input is reliable and the majority of the input is strongly biased in two or more opposite directions. As a result, the combined answer is likely more accurate, reliable, relevant, and appropriate than the answer 101 of any random user.

Using this theory, it is possible for a computer algorithm 105 to score a user based upon how their input corresponds to the process' answer 106. As users continue to use the process, the process will dynamically adjust the weight of new input 101 from user 107 based upon the past performance of user 107. Because all input is weighted according to past performance, this process will generate more accurate, reliable, relevant, and appropriate output than a process that does not consider past performance.

### Comment Moderation Process

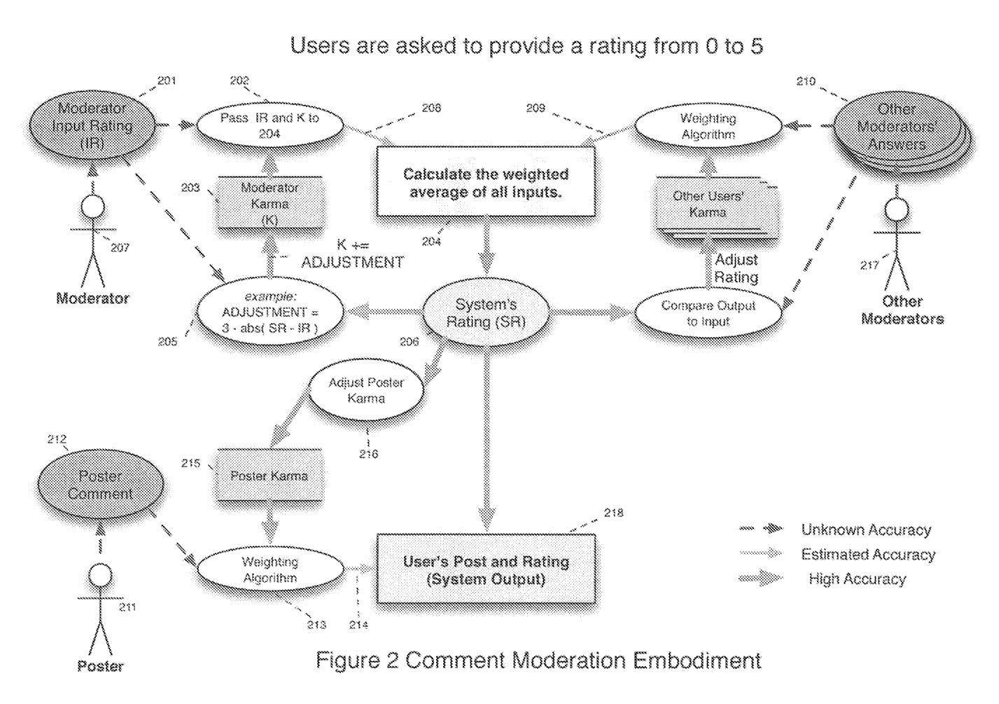

One aspect of the invention relates to use of the processes of the invention in a Comment Moderation Process. An example of a Comment Moderation Process according to the processes of the invention is provided in FIG. 2.

In such comment moderation embodiments, users can be asked to provide an objective rating for a particular comment. Each moderator 207 would contribute their answer 201 on a scale (for example, ranging from 0-5). The weighting algorithm 202 can assign a weight 203 to each user's answer to generate weighted answer 208. The weight 203, along with the answer 201, can be passed to the central algorithm 204 along with the weighted input 209 generated from other moderators' answers 210 provided by moderators 217. Based on this information, the central algorithm can calculate the weighted average of all user input. The rating adjustment algorithm 205 can compare the process' answer 206 to the user's answer 201. Algorithm 205 would then adjust the accuracy score or weight 203 by, for example, 3 minus absolute value of distance between their answer 201 and the process' answer 206. Users who are closer to the process' answer 206 are given more points than those who were further away. Any algorithm that produces positive adjustments for answers near the system answer and negative adjustments for answers farther from the system answer may be used. Users more than three units away are given negative adjustments to their rating.

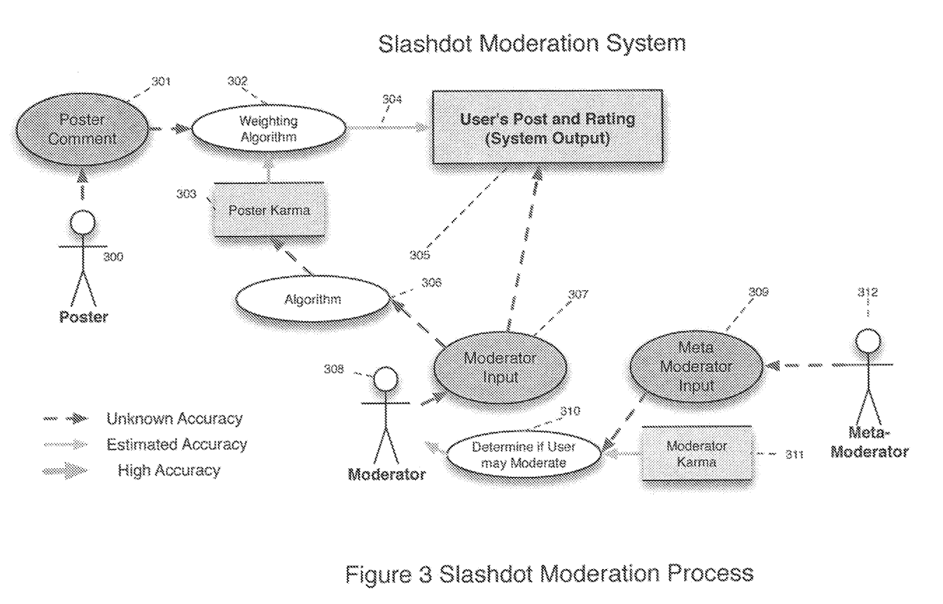

A better understanding of this embodiment of a Comment Moderation Process according to the present invention may be gleaned from a comparison of FIG. 3, which provides a process diagram that roughly shows how Slashdot works. For example, in the Slashdot system, the comment poster 300 provides a comment 301 that is processed by a weighting algorithm 302 that uses the poster's Karma 303 to provide an initial post 304. The post 305 is considered to be the output of the process and consists of the user comment 301 and an associated rating. Other users are selected to be moderators 308 based upon their Karma 311 and input 309 from meta-moderators 312. Moderator input 307 directly impacts the post 305 and the poster 300 by adjusting the poster's Karma 303. Additional users 312, who wish to meta-moderate are provided a random selection of moderations 307 to rate. This meta-moderation directly impacts the moderator points given to a user in the future.

The adjustments made in the processes of the present invention are significantly different from the adjustments being made in the Slashdot system. Algorithm of the Slashdot system and algorithm of the inventive moderation process make an adjustment to the Poster's Karma, however, there is a significant difference. Slashdot requires input from multiple meta-moderators in order to make an adjustment, whereas, the inventive process requires no additional input. The inventive moderation embodiment requires no meta-moderation input because meta-moderation is achieved by comparing the input provided by one moderator against the input provided by other moderators.

The Slashdot system uses input from other users asked to evaluate the input of another user's answer to a question; whereas, the inventive process asks all users the same question and automatically evaluates the quality of each individual's input. Most current systems require input from multiple users to generate a reliable output because no one user can be trusted. If theses systems wish to evaluate the quality of a user's input then they require multiple users to evaluate that input. The number of users required to evaluate the quality of an input grows exponentially, for example, as users start to rate the rating of a rating of a rating of a rating of a user's input. For this reason Slashdot stops at meta-moderation and most other systems do not even go that far.

If the embodiment of the comment moderation process of the present invention were applied to the Slashdot system, then all users could moderate at any time without the need for meta-moderators or limitations on how often a particular user could moderate. The result would be more input leading to a more accurate and precise moderation. Meta-moderators would not be needed because the process would automatically reward those who moderated well and punish those who did not. User Karma 203 in the comment moderation embodiment would not be subject to the direct user input that Karma 303 is subjected to in the Slashdot system. Direct user input introduces greater error to the Karma score than a comparison 205 with the process' rating 206. The algorithm presented above could also simplify the interface for the users of Slashdot because they would not have to consider concepts such as moderation points and meta-moderation.

### Truth Detection Embodiment

Another aspect of the present invention involves use of the processes of the invention for Truth Detection. In such embodiments, a user can be asked to rate a statement as true or false. User input can be identified, for example, as true being 1 and false being −1. The output of the process can be a truth rating ranging between −1 and 1. In a politically charged environment where people are strongly divided, the user input may be 55% true and 45% false. In such a situation with no clear majority, a simple average of the user input would be a value near 0, which doesn't give us any indication of the truth. We know, however, that most statements have an absolute truth; therefore, there should be a means to determine this truth.

The present invention has a means for determining the truth of the statement through such user input. If the statement is highly debated among the user population, it may be feasible that only 10% of the user population is providing objective answers, while 45% of the user population is strongly biased in one direction and the remaining 45% is strongly biased in an opposite direction. In this situation, the biased users would be wrong (farther from the average) more often than the non-biased users. Given this situation, the objective users' input would gain more and more weight as they consistently side on the right side of arguments. The biased users' input would not gain as much weight because they are wrong more often than the non-biased users. As a result, it would be possible to get a weighted average closer to −1 or 1 than a simple average would yield. This result would be more accurate, useful, and meaningful.

The methods of the present invention can achieve more accurate, useful, and meaningful results as compared to current methods of moderation and averaging. Neither simple averaging of user input nor users rating other users' input can provide meaningful output in a strongly divided user community. Moderation would not work because the moderation would be equally biased, and simple averaging will always yield a result near 0, which is not useful in this context. Additionally, it would be impractical if not impossible for a small team to analyze the user input simply because there is too much information to evaluate and the bias of that small team would be in question.

The process of the present invention can be applied to many problems. Other variations of the present invention include but are not limited to methods comprising moderation of other user input; different classes of users, such as expert users or users with different privileges and pre-defined trust levels; a mixture of questions with known and unknown answers to improve user-rating accuracy through comparison with a known truth; a graph among users to describe who trusts whom; multiple types of user ratings, for example, trust, accuracy, accuracy by category, precision, etc.; additional means to rate the user input automatically (for example, computer algorithms); allowing the user to estimate the accuracy of their own input; and allowing new user input to affect the weighting of past user input.

The embodiments listed above demonstrate how this process enables a whole new realm of applications that were not practical before. These embodiments enable people to become critical components of an algorithm designed to operate automatically. Many new algorithms may be developed that leverage human strengths because the process can automatically weight human input according to historical accuracy of an individual. Websites that currently require too much user moderation to be practical can now be implemented because the moderation is automatic and scales with the user input. The embodiments of this invention include all processes that use the output of the process to weight future user input to the process.

It will be apparent to those skilled in the art that various modifications and variations can be made in the practice of the present invention without departing from the scope or spirit of the invention. Other embodiments of the invention will be apparent to those skilled in the art from consideration of the specification and practice of the invention. It is intended that the specification and examples be considered as exemplary only.

1. A process for generating output from user input comprising:
(a) presenting at least one user with a question,
(b) gathering input from said at least one user,
(c) reading historic user data for said at least one user,
(d) generating an output using said input and said historic user data,
(e) comparing said output to said input to generate an adjustment factor, and
(f) adjusting said historic user data with said adjustment factor.

2. The process according to claim 1, wherein all of said presenting, gathering, reading, generating, comparing, and adjusting are performed consecutively at least two times.

3. The process according to claim 1 comprising storing said historic user data in at least one database.

4. The process according to claim 1, wherein said question is presented by way of a web page.

5. The process according to claim 1, wherein said input is gathered by way of a web page.

6. The process according to claim 1, wherein said question is presented by way of a desktop application.

7. The process according to claim 6, wherein said desktop application is networked by way of a client/server architecture.

8. The process according to claim 6, wherein said desktop application is networked by way of peer-to-peer connections.

9. The process according to claim 1, wherein said input is gathered by way of a desktop application.

10. The process according to claim 9, wherein said desktop application is networked by way of a client/server architecture.

11. The process according to claim 9, wherein said desktop application is networked by way of peer-to-peer connections.

12. Software for generating output from user input comprising instructions for:
(a) presenting at least one user with a question,
(b) gathering input from said at least one user,
(c) reading historic user data for said at least one user,
(d) generating an output using said input and said historic user data,
(e) comparing said output to said input to generate an adjustment factor, and
(f) adjusting said historic user data with said adjustment factor.

13. The software according to claim 12 comprising instructions for consecutively performing all of said presenting, gathering, reading, generating, comparing, and adjusting at least two times.

14. The software according to claim comprising instructions for reading said historic user data from data stored in at least one database.

15. The software according to claim 12 comprising instructions for presenting said question by way of a web page.

16. The software according to claim 12 comprising instructions for gathering said input by way of a web page.

17. The software according to claim 12 comprising instructions for presenting said question by way of a desktop application.

18. The software according to claim 17 comprising instructions for presenting said question by way of a desktop application, wherein said desktop application is networked by way of a client/server architecture.

19. The software according to claim 17 comprising instructions for presenting said question by way of a desktop application, wherein said desktop application is networked by way of peer-to-peer connections.

20. The software according to claim 12 comprising instructions for gathering said input by way of a desktop application.

21. The software according to claim 20 comprising instructions for gathering said input by way of a desktop application, wherein said desktop application is networked by way of a client/server architecture.

22. The software according to claim 20 comprising instructions for gathering said input by way of a desktop application, wherein said desktop application is networked by way of peer-to-peer connections.

23. A process for generating output from user input comprising:
(a) presenting at least one user with a question,
(b) gathering input from said at least one user,
(c) reading historic user data for said at least one user, and
(d) generating an output using said input and said historic user data.
